(19) United States
(12) Patent Application Publication
(10) Pub. No.: US 2006/0254469 A1
(43) Pub. Date: Nov. 16, 2006

(54) Additive for hydraulic material and concrete composition

(76) Inventors: Tsuyoshi Hirata, Kobe-shi, Hyogo (JP); Mari Masanaga, Suita-shi, Osaka (JP); Noboru Sakamoto, Takatsuki-shi, Osaka (JP); Hiroshi Ito, Kobe-shi, Hyogo (JP); Hirokazu Ito, Kobe-shi, Hyogo (JP)

Correspondence Address: MATHEWS, SHEPHERD, MCKAY, & BRUNEAU, P.A., 29 THANT ROAD, SUITE 201, PRINCETON, NJ, 08540, US

(21) Appl. No.: 10/558,857

(22) PCT Filed: Jun. 4, 2004
(86) PCT No.: PCT/JP04/08167

§ 371 Date: Nov. 30, 2005

(30) Foreign Application Priority Data
Jun. 6, 2003 (JP) 2003-162506

(51) Int. Cl. C04B 16/00; C04B 24/00

(52) U.S. Cl. 106/805; 106/806; 106/810

(57) ABSTRACT

A tetraalkoxy silane type additive for hydraulic material and/or a tetraalkoxy silane hydrolyzate type additive for hydraulic material are used as admixtures. The additive at a small amount efficiently improves the shrinkage reducing property, represses infliction of a crack, and imparts durability to the concrete structure.

### TECHNICAL FIELD

This invention relates to an additive for a hydraulic material such as concrete admixture and a concrete composition. This invention is used for forming a concrete which excels in such properties as strength, shrinkage reducing property, and durability.

### BACKGROUND ART

The additive for hydraulic material is capable of imparting excellent strength and durability and has been being used widely in such cement compositions as cement paste, mortar, and concrete. It is indispensable in the civil engineering and building construction.

In the concrete composition, after it has been hardened, the unreacted water component persisting therein is induced by the conditions including ambient temperature and humidity to scatter away. Then, the shrinkage by drying, which is thought to originate in this loss of the water component, proceeds and entails the problem of inflicting a crack on the hardened concrete composition and impairing the strength and durability thereof. When the civil engineering and building construction incurs impairment of strength and durability, such serious problems as decline of safety and addition to the cost of repair will ensue. Since the importance of the shrinkage reducing agent for hydraulic material which represses the advance of the shrinkage by drying in the civil engineering and building construction has been finding growing recognition, this shrinkage reducing agent has now become the target for energetic technical innovation.

Regarding the additive for hydraulic material which allays the shrinkage by drying and promotes the enhancement of the durability of the civil engineering and building construction, the technical innovation has been advancing actively. The additive for hydraulic material which is made of a silane type compound, for example, has been developed.

The official gazette of JP-A-H07-33497 has disclosed a chemical admixture which has a reactive silica compound and/or a silane compound as a main component thereof.

The official gazette of JP-A-H07-48159 has disclosed a chemical admixture which has hydrolytically active components (a silane polymer, a silane compound, and a hydrolytic silane derivative) as main components thereof.

For the sake of acquiring prescribed shrinkage reducing property and durability by the use of this additive for hydraulic material, it is necessary that the additive be added in a large amount. Thus, the additive for the hydraulic material has room for further improving the shrinkage reducing property and the durability with high efficiency.

### DISCLOSURE OF THE INVENTION

The object of the invention is to provide an additive for hydraulic material which permits efficient enhancement of shrinkage reducing property and durability and enjoys extensive versatility. By using the additive for hydraulic material which possesses these properties, this invention aims to reduce the cost of production of hydraulic material, repress sufficiently the advance of the shrinkage of a hardened hydraulic material, and enable the additive to manifest the fine effect of preventing infliction of a crack on the hardened hydraulic material. The other object of the invention is to provide a concrete composition using the additive for hydraulic material mentioned above.

This invention concerns a concrete composition which contains at least tetraalkoxy silane type additive for hydraulic material or tetraalkoxy silane hydrolyzate type additive for hydraulic material.

The tetraalkoxy silane type additive for hydraulic material mentioned above is preferably selected from the group consisting of tetraalkoxy silane, polyalkylene oxide derivative of tetraalkoxy silane, and acid derivative of tetraalkoxy silane.

The polyalkylene oxide derivatives of tetraalkoxy silane and the acid derivatives of tetraalkoxy silane mentioned above are preferred to be a compound represented by the following formula (1).
(R¹O)ₘSi(OR²)₄₋ₘ (1)

In the formula, R¹ denotes a hydrocarbon group having 1-30 carbon atoms, m denotes an integer of 0-3, R² identically or differently denotes -(AO)ₙR³, —(CR⁴R⁵)ₚCOOM, or —(CR⁶R⁷)_{g}SO₃Q, A denotes linear or branched hydrocarbon group having 2-18 carbon atoms, R³ denotes hydrogen atom or hydrocarbon group having 1-30 carbon atoms, R⁴—R⁷ identically or differently denote a hydrogen atom, a methyl group, or an ethyl group, M and Q identically or differently denote hydrogen, monovalent metal, divalent metal, ammonium, organic amine group, or —(BO)_{d}R⁸, B denotes a linear or branched hydrocarbon group having 2-18 carbon atoms, R⁸ denotes a hydrogen atom or a hydrocarbon group having 1-30 carbon atoms, n denotes an integer of 1-300, p and g identically or differently denote an integer of 1-10, and d denotes an integer of 1-300.

The polyalkylene oxide derivatives of tetraalkoxy silane and the acid derivatives of tetraalkoxy silane mentioned above may be compounds represented by the following formula (2).
(R⁹O)ᵣSi(OR¹⁰)₄₋ᵣ (2)

In the formula, R⁹ denotes a hydrocarbon group having 1-30 carbon atoms, r denotes an integer of 0-3, R¹⁰ denotes —(CR¹¹V¹—CR¹²V²—O)ₜR¹³, R¹¹ and R¹² identically or differently denote a hydrogen atom, a hydrocarbon group having 1-18 carbon atoms, or a side chain possessing a carboxyl group, V¹ and V² identically or differently denote a hydrogen atom or a side chain possessing a carboxyl group, the side chain possessing the carboxylic group possesses a repeating unit originating in an unsaturated carboxylic acid type monomer, R¹³ denotes a hydrocarbon group possessing 1-30 carbon atoms, t denotes an integer of 1-300, and R¹⁰ contains at least one carboxyl group.

The tetraalkoxy silane hydrolyzate type additive for hydraulic material mentioned above is selected from the group consisting of hydrolyzate of tetraalkoxy silane, compound obtained by hydrolyzing tetraalkoxy silane and subsequently subjecting the resultant hydrolyzate to derivation with a polyalkylene oxide, and compound obtained by hydrolyzing tetraalkoxy silane and subsequently subjecting the resultant hydrolyzate to derivation with an alkyl polyalkylene oxide.

The tetraalkoxy silane hydrolyzate type additive for hydraulic material mentioned above may be a compound obtained by adding an ethylenically unsaturated monomer containing at least an ethylenically unsaturated carboxylic acid type monomer to a tetraalkoxy oligomer and/or a polyalkylene oxide derivative thereof.

The concrete composition of this invention preferably further contains a water reducing admixture. The water reducing admixture is preferably a polycarboxylic acid type high-performance AE water reducing admixture.

This invention further concerns an additive for hydraulic material which comprises a transformed alkoxy silane acid.

The transformed alkoxy silane acid mentioned above preferably possesses a structure represented by the formula (3) or the formula (4).

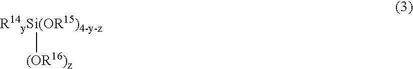

In the formula (3), R¹⁴ denotes a hydrocarbon group having 1-30 carbon atoms, y and z identically or differently denote an integer of 1-3 and satisfy 2≦y+z≦4, R¹⁵ denotes —(WO)_{b}R¹⁷, R¹⁶ identically or differently denotes —(CR¹⁸R¹⁹)ᵤCOOX or —(CR²⁰R²¹)ₕSO₃Y, W denotes a linear or branched hydrocarbon group having 2-18 carbon atoms, R¹⁷ denotes a hydrogen atom or a hydrocarbon group having 1-30 carbon atoms, R¹⁸—R²¹ identically or differently denote a hydrogen atom, a methyl group, or an ethyl group, X and Y identically or differently denote hydrogen, monovalent metal, divalent metal, ammonium, organic amine group, or -(DO)_{f}R²², R²² denotes a hydrogen atom or a hydrocarbon group having 1-30 carbon atoms, b denotes an integer of 1-300, u and h identically or differently denote an integer of 1-10, and f denotes an integer of 1-300.
R²³_{c}Si(OR²⁴)_{4-c} (4)

In the formula, R²³ denotes a hydrocarbon group having 1-30 carbon atoms, c denotes an integer of 1-3, R²⁴ denotes —(CR²⁵V³—CR²⁶V⁴—O)_{q}R²⁷, R²⁵ and R²⁶ identically or differently denote a hydrogen atom, a hydrocarbon group having 1-18 carbon atoms, or a side chain possessing a carboxyl group, V³ and V⁴ identically or differently denote a hydrogen atom or a side chain possessing a carboxyl group, the side chain possessing the carboxyl group possesses a repeating unit originating in an unsaturated carboxyl type monomer, R²⁷ denotes a hydrocarbon group having 1-30 carbon atoms, q denotes an integer of 1-300, and R²⁴ contains at least one carboxyl group.

This invention further concerns a concrete composition containing the additive for hydraulic material mentioned above. The concrete composition of this invention preferably contains a water reducing admixture.

When the silane type compound of this invention is used as the additive for hydraulic material, the application of this additive in a smaller amount enables the hardened hydraulic material to be efficiently improved in the shrinkage reducing property and the durability.

### BEST MODE FOR CARRYING OUT THE INVENTION

As concrete examples of the tetraalkoxy silane type additive for hydraulic material, tetraalkoxy silanes, polyalkylene oxide derivatives of tetraalkoxy silane, and acid derivatives of tetraalkoxy silane may be cited.

Though the tetraalkoxy silanes are not particularly restricted, they are preferred to be the compounds which are represented by the formula (5).
(RO)₄Si (5)

In the formula, R denotes identically or differently a hydrocarbon group having 1-30 carbon atoms.

The hydrocarbon groups having 1-30 carbon atoms in the formula (5) include alkyl groups having 1-30 carbon atoms; benzene ring-containing aromatic groups having 6-30 carbon atoms such as phenyl groups, alkyl phenyl groups, phenyl groups substituted with an alkyl phenyl group and naphthyl group; and alkenyl groups having 2-30 carbon atoms, for example.

The polyalkylene oxide derivatives of tetraalkoxy silane and the acid derivatives of tetraalkoxy silane mentioned above are preferred to be the compounds represented by the formula (1) mentioned above.

The hydrocarbon groups having 1-30 carbon atoms at R¹, R³, and R⁸ in the formula (1) include alkyl groups having 1-30 carbon atoms; benzene ring-containing aromatic groups having 6-30 carbon atoms such as phenyl groups, alkyl phenyl groups, phenyl groups substituted with an alkyl phenyl group and naphthyl group; and alkenyl groups having 2-30 carbon atoms, for example.

The number of carbon atoms of the oxyalkylene groups AO and BO fall preferably in the range of 2-18, more preferably 2-8, and still more preferably 2-4. As concrete examples of AO and BO, —(CH₂CH₂O)—, —(CH₂CH₂CH₂O)—, —(CH₂CH₂CH₂CH₂O)—, —(CH₂CH(CH₃)O)—, —(CH₂CH₂CH(CH₃)O)—, and —(CH(CH₃)CH(CH₃)O)— may be cited. The oxyalkylene groups may be formed of two or more species of oxyalkylene. The state of configuration in this case may be any of the states of block, random, and alternating.

The symbols n and d denote the numbers of a repeating oxyalkylene group, which fall preferably in the range of 1-300, more preferably 1-150, and still more preferably 1-100.

Then, M and Q denote hydrogen, monovalent metal, divalent metal, ammonium, organic amine group, or —(BO)_{d}R⁸. As concrete examples of the monovalent metal, lithium, sodium, potassium, etc. may be cited. As concrete examples of the divalent metal, calcium, magnesium, etc. may be cited. As concrete examples of the organic amine group, trimethyl amine group, triethyl amine group, ethanol amine group, etc. may be cited.

The polyalkylene oxide derivatives of tetraalkoxy silane and the acid derivatives of tetraalkoxy silane mentioned above may be the compounds represented by the formula (2) mentioned above. The explanations of the substituents, R⁹ and R¹³, of the formula (2) are omitted here because they are similar to those of the substituents, R¹, R³, and R⁸.

R¹⁰ denotes —(CR¹¹V¹—CR¹²V²—O)₁R¹³. That is, R¹⁰ possesses the repeating unit shown in the formula (6). The concrete configuration of the polyoxyalkylene group shown in the formula (6) is not specifically restricted. The polyoxyalkylene group may be formed of one species of oxyalkylene or two or more species of oxyalkylene.

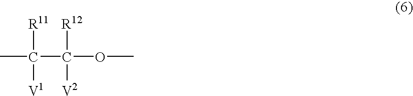

Here, R⁹ denotes a hydrocarbon group having 1-30 carbon atoms, r denotes an integer of 0-3, R¹⁰ denotes —(CR¹¹V¹—CR¹²V²—O)ₜR¹³, R¹¹ and R¹² identically or differently denote a hydrogen atom, a hydrocarbon group having 1-18 carbon atoms, or a side chain possessing a carboxyl group, V¹ and V² identically or differently denote a hydrogen atom or a side chain possessing a carboxyl group, the side chain possessing the carboxyl group possesses a repeating unit originating in an unsaturated carboxylic acid type monomer, R¹³ denotes a hydrocarbon group having 1-30 carbon atoms, t denotes an integer of 1-300, and R¹⁰ contains at least one carboxyl group.

The concrete composition may contain a compound which possesses therein a side chain other than the side chain represented by the formula (6). Preferably, one of R⁹ and R¹⁰ is a hydrogen atom and the other a hydrocarbon group having 1-18 carbon atoms.

As concrete examples of the hydrocarbon groups having 1-18 carbon atoms which are denoted by R¹¹ and R¹², alkyl groups having 1-18 carbon atoms; benzene ring-containing aromatic groups having 6-18 carbon atoms such as phenyl groups, alkyl phenyl groups, phenyl groups substituted with an alkyl phenyl group, and naphthyl groups; and alkenyl groups having 2-18 carbon atoms may be cited.

The side chain possessing a carboxyl group has a structure formed by polymerizing an ethylenically unsaturated monomer component having an unsaturated carboxylic acid type monomer as an essential component. This polymer is produced, for example, by graft polymerizing an ethylenically unsaturated monomer component containing an unsaturated carboxylic acid type monomer to a polyether compound as will be specifically described herein below. By adopting this procedure, the polymer component can be easily produced.

The symbol t in the formula (2) denotes the repeated number of a polyoxyalkylene having a side chain possessing a carboxyl group of tetraalkoxy silane. This number falls preferably in the range of 1-300, more preferably 1-150, and still more preferably 1-100.

As concrete examples of the side chain possessing a carboxyl group, the structures formed by graft polymerizing (meth)acrylic acid or maleic acid to such polyether compounds as polyethylene glycol, polypropylene glycol, and polyethylene polypropylene glycol.

The method for producing a polyalkylene oxide derivative from tetraalkoxy silane and an acid derivative from tetraalkoxy silane is not particularly restricted. Any of the known methods may be adopted for the derivation.

Now, concerning the polymer component of this invention, the methods for producing an ethylenically unsaturated monomer component, a polyether compound, and a polymer will be described below.

[Ethylenically Unsaturated Monomer Component]

The unsaturated carboxylic acid type monomer in the ethylenically unsaturated monomer component is a monomer having at least one polymerizing unsaturated bond and at least one carboxyl group in the molecular. It preferably contains an unsaturated monocarboxylic acid type monomer, and an α,β-unsaturated dicarboxylic acid type monomer and/or an anhydride thereof as essential components. These components may be each used either singly or in the form of a combination of two or more species. When the α,β-unsaturated dicarboxylic acid type monomer and/or the anhydride thereof is contained as an essential component, the abrupt increase of viscosity owing to the run-away of the polymerization can be precluded. The content of the unsaturated carboxylic acid type monomer in the ethylenically unsaturated monomer component is not particularly restricted so long as it can manifest the function and effect of the present invention. This unsaturated carboxylic acid type monomer is preferably contained as a main component, for example. Other components may be or may not be contained.

As concrete examples of the unsaturated monocarboxylic acid type monomer, (meth) acrylic acid, crotonic acid, tiglic acid, 3-methylcrotonic acid, and 2-methyl-2-pentenoic acid may be cited. Among those compounds, (meth)acrylic acid is preferable in respect to availability.

As concrete examples of the α,β-unsaturated dicarboxylic acid type monomer and/or the anhydride thereof, α,β-unsaturated dicarboxylic acids such as maleic acid, fumaric acid, mesaconic acid, and citraconic acid; and α,β-unsaturated dicarboxylic anhydrides such as maleic anhydride and citraconic anhydride may be cited. Among them, at least one compound selected from the group consisting of maleic acid, fumaric acid, and maleic anhydride is preferably used herein in respect to availability.

The content of the α,β-unsaturated dicarboxylic acid type monomer and/or the anhydride thereof in the unsaturated carboxylic acid type monomer is preferably in the range of 0.1-99.9 weight %, more preferably 1-99 weight %, still more preferably 10-90 weight %, and particularly preferably 20-80 weight % to make the monomer to be graft polymerized at a proper speed and preventing the viscosity from being increased.

One preferred embodiment of the ethylenically unsaturated monomer component in the present invention contains an α,β-unsaturated dicarboxylic acid type monomer and (meth)acrylic acid as essential components. The weight ratio of the α,β-unsaturated dicarboxylic acid type monomer to the (meth)acrylic acid in this form is preferably in the range of 1/99-99/1, more preferably 5/95-95/5, still more preferably 10/90-90/10, and particularly preferably 15/85-85/15.

The ethylenically unsaturated monomers, which can be contained in the ethylenically unsaturated monomer component other than unsaturated carboxylic acid type monomers, include ethylenically unsaturated carboxylic esters and other ethylenically unsaturated monomers, for example. These monomers can be used either singly or in the form of a combination of two or more members. As concrete examples of the ethylenically unsaturated carboxylic esters, alkyl esters of maleic acid such as monomethyl maleate, dimethyl maleate, monoethyl maleate, and diethyl maleate; alkyl esters of fumaric acid such as monomethyl fumarate, dimethyl fumarate, monoethyl fumarate, and diethyl fumarate; alkyl(meth)acrylates such as methyl(meth)acrylate, ethyl (meth)acrylate, butyl(meth)acrylate, and stearyl(meth)acrylate; hydroxyl group-containing unsaturated carboxylic esters such as hydroxyalkyl(meth)acrylates including hydroxyethyl(meth)acrylate and hydroxypropyl(meth)acrylate; and polyalkylene glycol(meth)acrylates such as (methoxy)polyethylene glycol(meth)acrylate, phenoxy polyethylene glycol(meth)acrylate, naphthoxy polyethylene glycol(meth)acrylate, monophenoxy polyethylene glycol maleate, and carbazol polyethylene glycol(meth)acrylate may be cited.

As concrete examples of the ethylenically unsaturated monomer other than the ethylenically unsaturated carboxylic esters, aromatic vinyl type monomers such as styrene; amide group-containing vinyl type monomers such as (meth)acryl amide and (meth)acrylalkyl amides; vinyl esters such as vinyl acetate, vinyl propionate, vinyl pivalate, vinyl benzoate, and vinyl cinnamate; alkenes such as ethylene and propylene; dienes such as butadiene and isoprene; trialkyloxy silyl group-containing vinyl type monomers such as vinyl trimethoxy silane and vinyl triethoxy silane; silicon atom-containing vinyl type monomers such as γ-(methacryloyloxypropyl)trimethoxy silane; and maleimide derivatives such as maleimide, methyl maleimide, ethyl maleimide, propyl maleimide, butyl maleimide, octyl maleimide, dodecyl maleimide, stearyl maleimide, phenyl maleimide, and cyclohexyl maleimide may be cited.

As other examples, nitrile group-containing vinyl type monomers such as (meth)acrylonitrile; aldehyde group-containing vinyl type monomers such as (meth)acrolein; amino group-containing vinyl type monomers such as dialkylaminoethyl(meth)acrylates including dimethyl aminoethyl(meth)acrylate; unsaturated ethers such as (methoxy)polyethylene glycol(meth)allyl ether and (methoxy)polyethylene glycol isopropenyl ether; sulfonic acid group-containing vinyl type monomers such as 2-acrylamide-2-methyl propane sulfonic acid, (meth)allyl sulfonic acid, 2-sulfoethyl (meth)acrylate, vinyl sulfonic acid, hydroxyallyloxy propane sulfonic acid, and styrene sulfonic acid; and other functional group-containing vinyl type monomers such as vinyl chloride, vinylidene chloride, allyl chloride, allyl alcohol, vinyl pyrrolidone, and ethylvinyl ether may be cited.

[Method for Production of Polymer Component]

The graft polymerization for preparing the polymer component in the present invention is implemented by using the graft site generated during the extraction of a hydrogen atom or a halogen atom from the polyether compound as the point for initiating the addition polymerization of an ethylenically unsaturated monomer.

The method for the graft polymerization is not particularly restricted but is only required to be capable of graft polymerizing an ethylenically unsaturated monomer to the polyether compound. The polymerization is effected, for example, in the presence of a polymerization initiator in respect that the performance of a hydrophilic graft polymer can be exalted by increasing the grafting ratio. The polymerization initiator is not particularly restricted but may be arbitrarily selected from known radical initiators organic peroxides prove particularly advantageous from the viewpoint of reactivity, for example.

The organic peroxide is not particularly restricted. The organic peroxides enumerated in (1)-(8) below may be cited as concrete examples of this organic peroxide. These organic peroxides may be used either singly or in the form of a combination of two or more members. (1) Ketone peroxides: methylethyl ketone peroxide, cyclohexanone peroxide, 3,3,5-trimethyl cyclomethylethyl ketone peroxide, 3,3,5-trimethyl cyclohexanone peroxide, methyl cyclohexanone peroxide, methyl acetoacetate peroxide, and acetyl acetone peroxide. (2) Hydroperoxides: tert-butyl hydroperoxide, cumene hydroperoxide, diisopropyl benzene hydroperoxide, 2,5-dimethylhexane-2,5-dihydroperoxide, 1,1,3,3-tetramethylbutyl hydroperoxide, and 2-(4-methyl cyclohexyl)-propane hydroperoxide. (3) Dialkyl peroxides: di-tert-butyl peroxide, tert-butyl cumyl peroxide, dicumyl peroxide, α,α′-bis(tert-butyl peroxy)-p-diisopropyl benzene, α,α′-bis(tert-butyl peroxy)-p-isopropyl hexine, 2,5-dimethyl-1,5-di(tert-butyl peroxy)-hexane, and 2,5-dimethyl-2,5-di(tert-butyl peroxy)-hexine-3. (4) Peroxy esters: tert-butyl peroxy acetate, tert-butyl peroxy laurate, tert-butyl peroxy benzoate, di-tert-butyl peroxy isophthalte, 2,5-dimethyl-2,5-di(benzoyl peroxy) hexane, tert-butyl peroxy isopropyl carbonate, tert-butyl peroxy isobutylate, tert-butyl peroxy pivalate, tert-butyl peroxy neodecanoate, cumyl peroxy neodecanoate, tert-butyl peroxy-2-ethyl exanoate, tert-butyl peroxy-3,5,5-trimethyl hexanoate, tert-butyl peroxy maleic acid, cumyl peroxy octoate, tert-hexyl peroxy pivalate, tert-hexyl peroxy neohexanoate, and cumyl peroxy neohexanoate. (5) Peroxy ketals: n-butyl-4,4-bis(tert-butyl peroxy)valeate, 2,2-bis(tert-butyl peroxy)butane, 1,1-bis(tert-butyl peroxy)-3,3,5-trimethyl cyclohexane, 1,1-bis(tert-butyl peroxy) cyclohexane, and 2,2-bis(tert-butyl peroxy)octane. (6) Diacyl peroxides: acetyl peroxide, isobutyryl peroxide, octanoyl peroxide, decanoyl peroxide, lauroyl peroxide, 3,3,5-trimethyl cyclohexanoyl peroxide, succinic acid peroxide, benzoyl peroxide, 2,4-dichlorobenzoyl peroxide, and m-toluyl peroxide. (7) Peroxydicarbonates: diisopropyl peroxy dicarbonate, di-2-ethylhexyl peroxy dicarbonate, di-n-propyl peroxy dicarbonate, bis-(4-tert-butyl cyclohexyl) peroxy dicarbonate, dimyristyl peroxy dicarbonate, di-methoxy isopropyl peroxy dicarbonate, di(3-methyl-3-methoxybutyl) peroxy dicarbonate, and di-allyl peroxy dicarbonate. (8) Other organic peroxides: acetylcyclohexyl sulfonyl peroxide and tert-butyl peroxy allyl carbonate.

In the graft polymerization, the decomposing catalyst for an organic peroxide and a reducing compound may be used in combination with the organic peroxide. When the graft polymerization is carried out by adding an ethylenically unsaturated monomer to the polyether compound, the polymerization initiator may be added in advance to the polyether compound, it may be added to the ethylenically unsaturated monomer component, or it may be added to the reaction system simultaneously with the ethylenically unsaturated monomer component. Though the amount of the polymerization initiator to be used is not particularly restricted, it is properly in the range of 0.1-15 weight % and more preferably 0.5-10 weight %. If this amount falls short of 0.1 weight % or exceeds 15 weight %, the deviation will possibly result in lowering the grafting ratio to the polyether compound.

The graft polymerization can be carried out by known polymerization method such as solution polymerization or bulk polymerization. The solvent to be used in carrying out the solution polymerization is not particularly restricted. It is preferred to be incapable of exerting an adverse effect on the efficiency of polymerization. As concrete examples of the solvent, water; hydrocarbon type solvents such as n-butane, propane, benzene, cyclohexane, and naphthalene; halogenated hydrocarbon type solvents such as methyl chloride, chloroform, carbon tetrachloride, and trichloroethane; alcohol type solvents such as propanol, butanol, isopropyl alcohol, isobutyl alcohol, and isoamyl alcohol; ether type solvents such as ethyl ether, isopropyl ether, and butyl ether; ketone type solvents such as methylethyl ketone, ethylbutyl ketone, and methylisobutyl ketone; ester type solvents such as methyl acetate, ethyl acetate, ethyl benzoate, and ethyl lactate; acid type solvents such as formic acid, acetic acid, and propionic acid; and polyhydric alcohols such as (poly)ethylene glycol, ethylene glycol monobutyl ether, ethylene glycol monobutyl ether acetate, tetraethyleneglycol, and propylene glycol monobutyl ether and derivatives thereof may be cited. These solvents may be used either singly or in the form of a combination of two or more members.

The graft polymerization may be performed either batchwise or continuously. The temperature of the graft polymerization is preferably in the range of 80-160° C. and more preferably 100-160° C. If this temperature is lower than 80° C., the shortage will possibly prevent the graft polymerization from proceeding smoothly and degrading the efficiency of grafting of the polyether compound to the ethylenically unsaturated monomer. If the temperature exceeds 160° C., the excess will possibly result in causing the polyether compound as the raw material and the produced graft polymer to undergo thermal decomposition.

In the graft polymerization, the polyether compound is preferably placed either partially or wholly in the polymerization vessel during the initial stage of the polymerization. When the ethylenically unsaturated monomer component contains an α,β-unsaturated dicarboxylic acid type monomer, namely at least one monomer selected from the group consisting of maleic acid, fumaric acid, and maleic anhydride, in conjunction with (meth)acrylic acid, it is preferable to have more than one half of the α,β-unsaturated dicarboxylic acid type monomer mixed in advance with the polyether compound. Then, after this mixture has been heated to a temperature exceeding the pour point of the polyether compound, the resultant mixture and the remainder of the ethylenically unsaturated monomer and the polymerization initiator separately added thereto are together made to undergo graft polymerization. By this method, the introduction rate of the α,β-unsaturated dicarboxylic acid type monomer into the graft polymer can be greatly exalted.

The amount of the ethylenically unsaturated monomer component to be used is not particularly restricted. The amount of the unsaturated carboxylic acid type monomer contained in the ethylenically unsaturated monomer component is preferably in the range of 0.1-100 parts by weight, more preferably 1-80 parts by weight, and still more preferably 2-65 parts by weight, based on 100 parts by weight of the polyether compound. If this amount falls short of 0.1 parts by weight, the shortage will possibly prevent the polymer from acting easily on cement and induce impairment of the performance of the polymer. If the amount exceeds 100 parts by weight, the excess will possibly result in aggravating the delay in the curing with the polymer and increasing the viscosity of the reaction mixture to the extent of rendering difficult the handling thereof.

The polymer which is obtained by the graft polymerization may be used in its unmodified form as the admixture for the hydraulic material or may be used as dissolved in a solvent. As concrete examples of the solvent, water, alcohols, and their likes may be cited. Preferably, water is used. When the polymer contains a carboxyl group or an acid group such as sulfonic acid group or an ester group thereof, the salt obtained by partly or wholly converting the acid group or the ester group by the addition of a base may be used as an additive.

The base is not particularly restricted. As examples of the base, hydroxides of alkali metals and alkaline earth metals such as sodium hydroxide, potassium hydroxide, calcium hydroxide, and lithium hydroxide; carbonates of alkali metals and alkaline earth metals such as sodium carbonate, calcium carbonate, and lithium carbonate; and amines such as ammonia, monoethanol amine, diethanol amine, and triethanol amine may be cited. These bases may be used either singly or in the form of a combination of two or more members.

The method for implementing the graft polymerization is not restricted to the method described above. It may be arbitrarily selected from among the methods disclosed in EP-639592, EP-754712, JP-A-11-279220, etc.

The concrete composition of this invention may contain a tetraalkoxy silane hydrolyzate type additive for hydraulic material.

Though the tetraalkoxy silane hydrolyzate type compound to be used in this invention is not particularly restricted, it is preferably selected from the group consisting of hydrolyzate of tetraalkoxy silane, compound obtained by hydrolyzing a tetraalkoxy silane and then subjecting the resultant hydrolyzate to derivation with an polyalkylene oxide, and compound obtained by hydrolyzing a tetraalkoxy silane and then subjecting the resultant hydrolyzate to derivation with an alkylpolyalkylene oxide. These compounds are preferred to be prepared by using tetraalkoxy silane as the starting material.

The tetraalkoxy silane hydrolyzate type additive for hydraulic material may be a compound obtained by adding an ethylenically unsaturated monomer containing at least an ethylenically unsaturated carboxylic acid type monomer to tetraalkoxy oligomer and/or a polyalkylene oxide derivative thereof.

The term “tetraalkoxy silane oligomer” refers to a hydrolyzate having a tetraalkoxy silane as a main component and optionally using a trialkoxy silane compound, a dialkoxy silane compound, or a monoalkoxy silane compound. As components other than tetraalkoxysilane, alkylalkoxy silane, mercaptoalkyl alkoxy silane, etc. may be cited.

As concrete examples of the monomer to be used while adding an ethylenically unsaturated monomer containing an ethylenically unsaturated carboxylic acid type monomer, unsaturated monocarboxylic acid type monomers such as acrylic acid, methacrylic acid, crotonic acid, and metal salts, ammonium salts, and amine salts thereof; unsaturated dicarboxylic acids such as maleic acid, itaconic acid, citraconic acid, fumaric acid, and metal salts, ammonium salts, and amine salts thereof; and anhydrides such as maleic anhydride, itaconic anhydride, and citranoic anhydride may be cited. Among other monomers enumerated above, unsaturated monocarboxylic acid, maleic acid, and metal salts thereof, and maleic anhydride are preferably used and acrylic acid, methacrylic acid, and metal salts thereof are particularly preferably used.

As the structures for ethylenically unsaturated carboxylic acid type monomers, the structures of the following formula may be cited.
CR²⁸H═CR²⁹—(CH₂)ₙ—COO(AO)ₖR³⁰

In this formula, R²⁸ and R²⁹ identically or differently denote a hydrogen atom or a methyl group, R³⁰ denotes a hydrogen atom or a hydrocarbon group having 1-30 carbon atoms, n denotes an integer of 0-2, k denotes an integer of 1-300, and AO identically or differently denotes an oxyalkylene group having 2-18 carbon atoms. R³⁰ is preferably a hydrogen atom or a hydrocarbon group having 1-18 carbon atoms, more preferably a hydrogen atom or a hydrocarbon group having 1-12 carbon atoms, and still more preferably a hydrogen atom or a hydrocarbon group having 1-8 carbon atoms.

As concrete examples of the ethylenically unsaturated monomer, the following compounds may be cited.

Various alkoxy(poly)ethylene glycol mono(meth)acrylates such as methoxy(poly)ethylene glycol mono(meth)acrylate, ethoxy(polyethylene glycol mono(meth)acrylate, 1-propoxy(poly)ethylene glycol mono(meth)acrylate, 2-propoxy(poly)ethylene glycol mono(meth)acrylate, 1-butoxy(poly)ethylene glycol mono(meth)acrylate, 2-butoxy(poly)ethylene glycol mono(meth)acrylate, 2-methyl-1-propoxy(poly)ethylene glycol mono(meth)acrylate, 2-methyl-2-propoxy(poly)ethylene glycol mono (meth) acrylate, 1-pentyloxy(poly)ethylene glycol mono(meth)acrylate, 1-hexyloxy(poly)ethylene glycol mono(meth)acrylate, cyclohexyloxy (poly)ethylene glycol mono(meth)acrylate, 1-octyloxy (poly)ethylene glycol mono(meth)acrylate, 2-ethyl-1-hexyloxy(poly)ethylene glycol mono(meth)acrylate, nonylalkoxy(poly)ethylene glycol mono(meth)acrylate, laurylalkoxy(poly)ethylene glycol mono(meth)acrylate, cetylalkoxy(poly)ethylene glycol mono(meth)acrylate, stearylalkoxy(poly)ethylene glycol mono(meth)acrylate, phenoxy(poly)ethylene glycol mono(meth)acrylate, phenylmethoxy(poly)ethylene glycol mono(meth)acrylate, methylphenoxy(poly)ethylene glycol mono(meth)acrylate, p-ethylphenoxy(poly)ethylene glycol mono(meth)acrylate, dimethylphenoxy(poly)ethylene glycol mono(meth)acrylate, p-t-butylphenoxy(poly)ethylene glycol mono(meth)acrylate, nonylphenoxy(poly)ethylene glycol mono(meth)acrylate, and dodecylphenoxy(poly)ethylene glycol mono(meth)acrylate; and esters of ethylene oxide-added allyl alcohol and acrylic acid, esters of ethylene oxide-added methallyl alcohol and acrylic acid, and esters of ethylene oxide-added crotyl alcohol and acrylic acid.

Various alkoxy(poly)propylene glycol mono(meth)acrylates such as methoxy(poly)propylene glycol mono(meth)acrylate, ethoxy(poly)propylene glycol mono(meth)acrylate, 1-propoxy(poly)propylene glycol mono(meth)acrylate, 2-propoxy(poly)propylene glycol mono(meth)acrylate, 1-butoxy(poly)propylene glycol mono(meth)acrylate, 2-butoxy(poly)propylene glycol mono(meth)acrylate, 2-methyl-1-propoxy(poly)propylene glycol mono(meth)acrylate, 2-methyl-2-propoxy(poly)propylene glycol mono(meth)acrylate, 1-pentyloxy(poly)propylene glycol mono(meth)acrylate, 1-hexyloxy(poly)propylene glycol mono (meth) acrylate, cyclohexyloxy(poly)propylene glycol mono(meth)acrylate, 1-octyloxy(poly)propylene glycol mono(meth)acrylate, 2-ethyl-hexyloxy (poly)propylene glycol mono(meth)acrylate, nonylalkoxy(poly)propylene glycol mono(meth)acrylate, laurylalkoxy(poly)propylene glycol mono(meth)acrylate, cetylalkoxy(poly)propylene glycol mono(meth)acrylate, stearylalkoxy(poly)propylene glycol mono(meth)acrylate, phenoxy(poly)propylene glycol mono(meth)acrylate, phenylmethoxy(poly)propylene glycol mono(meth)acrylate, methylphenoxy(poly)propylene glycol mono(meth)acrylate, p-ethylphenoxy(poly)propylene glycol mono(meth)acrylate, dimethylphenoxy(poly)propylene glycol mono(meth)acrylate, p-t-butylphenoxy(poly)propylene glycol mono(meth)acrylate, nonylphenoxy(poly)propylene glycol mono(meth)acrylate, and dodecylphenoxy(poly)propylene glycol mono(meth)acrylate; and esters of propylene oxide-added allyl alcohol and acrylic acid, esters of propylene oxide-added methallyl alcohol and acrylic acid, and esters of propylene oxide-added crotyl alcohol and acrylic acid.

Various alkoxy(poly)ethylene(poly)propylene glycol mono(meth)acrylates such as methoxy(poly)ethylene(poly)propylene glycol mono(meth)acrylate, ethoxy(poly)ethylene(poly)propylene glycol mono(meth)acrylate, 1-propoxy(poly)ethylene(poly)propylene glycol mono(meth)acrylate, 2-propoxy(poly)ethylene(poly)propylene glycol mono(meth)acrylate, 1-butoxy(poly)ethylene(poly)propylene glycol mono(meth)acrylate, 2-butoxy (poly)ethylene(poly)propylene glycol mono(meth)acrylate, 2-methyl-1-propoxy(poly)ethylene(poly)propylene glycol mono(meth)acrylate, 2-methyl-2propoxy(poly)ethylene(poly)propylene glycol mono(meth)acrylate, 1-pentyloxy(poly)ethylene(poly)propylene glycol mono(meth)acrylate, 1-hexyloxy(poly)ethylene (poly)propylene glycol mono(meth)acrylate, cyclohexyloxy(poly)ethylene(poly)propylene glycol mono(meth)acrylate, 1-octyloxy(poly)ethylene(poly)propylene glycol mono(meth)acrylate, 2-ethyl-1-hexyloxy(poly)ethylene(poly)propylene glycol mono(meth)acrylate, nonyl alkoxy(poly)ethylene(poly)propylene glycol mono(meth)acrylate, lauryl alkoxy(poly)ethylene(poly)propylene glycol mono(meth)acrylate, cetyl alkoxy(poly)ethylene(poly)propylene glycol mono(meth)acrylate, stearyl alkoxy(poly)ethylene(poly)propylene glycol mono(meth)acrylate, phenoxy(poly)ethylene(poly)propylene glycol mono(meth)acrylate, phenyl methoxy(poly)ethylene(poly)propylene glycol mono(meth)acrylate, methyl phenoxy(poly)ethylene(poly)propylene glycol mono(meth)acrylate, p-ethylphenoxy(poly)ethylene(poly)propylene glycol mono(meth)acrylate, dimethylphenoxy(poly)ethylene(poly)propylene glycol mono(meth)acrylate, p-t-butyl phenoxy(poly)ethylene(poly)-propylene glycol mono(meth)acrylate, nonyl phenoxy(poly)ethylene(poly)propylene glycol mono(meth)acrylate, and dodecyl phenoxy(poly)ethylene(poly)propylene glycol mono(meth)-acrylate; and esters of ethylene oxide and propylene oxide-added allyl alcohol and acrylic acid, esters of ethylene oxide and propylene oxide-added methallyl alcohol and acrylic acid, and esters of ethylene oxide and propylene oxide-added crotyl alcohol and acrylic acid.

The following method is available, for example, for the addition of an ethylenically unsaturated monomer to tetraalkoxy silane oligomer and/or a polyalkylene oxide derivative thereof. An ethylenically unsaturated carboxylic acid type monomer and an ethylenically unsaturated monomer possessing no carboxylic acid are polymerized by using a mercapto group-containing tetraalkoxy silane oligomer as a chain transfer agent and using a polymerization initiator. This polymerization may be solvent polymerization or bulk polymerization. The polymerization in a solvent may be performed batchwise or continuously. As concrete examples of the solvent to be used during this polymerization, water; lower alcohols such as methyl alcohol, ethyl alcohol, and 2-propanol; aromatic hydrocarbons such as benzene, toluene, and xylene; aliphatic hydrocarbons such as cyclohexane and n-hexane; and ketone compounds such as acetone and methylethyl ketone may be cited. In consideration of the solubility of the raw material monomer and the added reactants, the use of water or a lower alcohol having 1-4 carbon atoms is recommendable.

When the polymerization uses water as the solvent, it can use ammonium or an alkali metal persulfate or hydrogen peroxide as the polymerization initiator. In this case, such a promoter as sodium hydrogen sulfite, Mohr's salt, ascorbic acid (salt), or Rongalit acid may be additionally used. When the polymerization uses a lower alcohol, an aromatic hydrocarbon, an aliphatic hydrocarbon, or a ketone compound as the solvent, a peroxide such as benzoyl peroxide or lauroyl peroxide; a hydroperoxide such as cumeme hydroperoxide; or an azo compound such as azo isobutylonitrile may be used as the polymerization initiator. When the polymerization uses a mixed solvent composed of water and a lower alcohol, the polymerization initiator may be properly selected from among various polymerization initiators mentioned above and combinations of polymerization initiators and promoters. Though the polymerization temperature varies with the kind of solvent and the kind of polymerization initiator to be used, it generally falls in the range of 0-120° C.

When the polymerization is performed in the form of bulk polymerization, such peroxides as benzoyl peroxide and lauroyl peroxide and such azo compounds as azo isobutylonitrile are available as the polymerization initiator. The polymerization temperature generally falls in the range of 40-200° C.

This invention further concerns an additive for hydraulic material which contains transformed alkoxy silane acid. The term “transformed alkoxy silane acid” means a compound which possesses a structure incorporating therein a carboxylic acid or a sulfonic acid. Though the concrete structure of transformed alkoxy silane acid is not particularly restricted, the structure represented by the formula (3) or the formula (4) proves favorable.

As concrete examples of the hydrocarbon groups of 1-30 carbon atoms which are denoted by R¹⁴, R^{17,} and R²² in the formula (3), hydrocarbon groups having 1-30 carbon atoms; benzene ring-containing aromatic groups having 6-30 carbon atoms such as phenyl group, alkylphenyl groups, phenyl groups substituted with an (alkyl)phenyl group, and naphthyl group; and alkenyl groups having 2-30 carbon atoms may be cited.

The number of carbon atoms of the oxyalkylene groups WO and DO fall preferably in the range of 2-18, more preferably 2-8, and still more preferably 2-4. As concrete examples of WO and DO, —(CH₂CH₂O)—, —(CH₂CH₂CH₂O)—, —(CH₂CH₂CH₂CH₂O)—, —(CH₂CH(CH₃)O)—, —(CH₂CH₂CH—(CH₃)O)—, and —(CH(CH₃)CH(CH₃)O)— may be cited. The oxyalkylene group may be formed of two or more species of oxyalkylene. The state of configuration in this case may be any of the states of block, random, and alternating.

The symbols band f denote repeated numbers of oxyalkylene group. The numbers fall preferably in the range of 1-300, more preferably 1-150, and still more preferably 1-100.

Then, X and Y each denote hydrogen, monovalent metal, divalent metal, ammonium, organic amine group, or -(DO)_{d}R²². As concrete examples of the monovalent metal, lithium, sodium, and potassium may be cited. As concrete examples of the divalent metal, calcium and magnesium may be cited. As concrete examples of the organic amine group, trimethyl amine group, triethyl amine group, and ethanol amine group may be cited.

The transformed alkoxy silane acid may be a compound represented by the formula (4) mentioned above.

As concrete examples of the hydrocarbon groups of 1-30 carbon atoms denoted by R²³ and R²⁷ in the formula (4), alkyl groups having 1-30 carbon atoms; benzene ring-containing aromatic groups having 6-30 carbon atoms such as phenyl group, alkylphenyl groups, phenyl groups substituted with an (alkyl)phenyl group, and naphthyl group; and alkenyl groups having 2-30 carbon atoms may be cited.

The explanation of (OR²⁴) is omitted here because it is similar to the explanation of (OR¹⁰) mentioned above. R²⁴, R²⁵, R²⁶, R²⁷, V³, V⁴, and q correspond respectively to R¹⁰, R¹¹, R¹², R¹³, V¹, V², and t.

The additive for hydraulic material which contains a transformed alkoxy silane acid is contained in the cement composition. The cement composition containing the additive for hydraulic material according to this invention is such that the application thereof in a smaller amount enables the hardened hydraulic material to be efficiently improved in the shrinkage reducing property and the durability.

The concrete composition for hydraulic material of the present invention may further contain a water-reducing admixture (cement dispersing agent). This water-reducing admixture is not particularly restricted but is only required to be capable of dispersing cement particles. As examples of the water-reducing admixture, lignin sulfonic acid and water-reducing admixtures of the polycarboxylic acid type, naphthalene type, melamine type, and aminosulfonic acid type may be cited besides the known cement dispersing agents and water-reducing admixtures. These water-reducing admixtures may be used either singly or in the form of a combination of two or more members. By the inclusion of such a water-reducing admixture, it is possible to improve the cement additive in the action to disperse the particles in the hydraulic material. As a result, the hydraulic material will be made to excel in fluidity, exalt workability markedly, and derive improvement in strength and durability of the hardened mass owing to the reduction of the amount of water contained in the hydraulic material.

The lignin sulfonic acid and the like which are cited as water-reducing admixtures are generally called air-entraining and water-reducing admixtures. The water-reducing admixtures of the polycarboxylic acid type, naphthalene type, melamine type, and aminosulfonic acid type are generally called air-entraining and high-range water-reducing admixtures. Among other water-reducing admixtures, air-entraining and high-range water-reducing admixtures are used preferably and polycarboxylic acid type air-entraining and high-range water-reducing admixtures are used more preferably.

The compounding ratio of the admixture composition for hydraulic material and the cement dispersing agent is not particularly restricted. When the air-entraining and high-range water-reducing admixture is used as the cement dispersing agent, for example, the solids weight ratio of the admixture composition/air-entraining and high-range water-reducing admixture is preferably in the range of 1/100-100/1, more preferably 1/100-50/1, and still more preferably 1/100-25/1. If the amount of the admixture for hydraulic material to be added exceeds the upper limit of the range of weight ratio, the excess will possibly result in impairing the water reducing property of the air-entraining and high-range water-reducing admixture.

The admixture composition for hydraulic material, when necessary, may further contain the solvents and the other components so long as their addition avoids preventing the present invention from manifesting the action and effect inherent therein. For example, known additives (materials) in following (1)-(9) may be used.

(1) Water soluble macromolecular substances: unsaturated carboxylic acid polymers such as (sodium)polyacrylate, (sodium)polymethacrylate, (sodium)polymaleate, and sodium salts of acrylic acid-maleic acid copolymers; nonionic cellulose ethers such as methyl cellulose, ethyl cellulose, hydroxymethyl cellulose, hydroxyethyl cellulose, carboxymethyl cellulose, carboxyethyl cellulose, and hydroxypropyl cellulose; polysaccharides produced by microorganic fermentation of yeast glucan, xanthane gum, β-1,3-glucanes (of both linear and branched forms such as, for example, curdlan, parmylum, pachyman, scleroglucan, and laminaran); polyacrylamide; polyvinyl alcohol; starch; starch phosphoric esters; sodium alginate; gelatin; and copolymers of acrylic acid containing an amino group in the molecular unit thereof and quaternized compounds thereof. (2) Macromolecular emulsions: copolymers of various vinyl monomers such as alkyl(meth)acrylates, etc.; (3) Retarding agents: oxycarboxylic acids and salts thereof such as gluconic acid, glucoheptonic acid, arabonic acid, malic acid, and citric acid and inorganic and organic salts thereof with sodium, potassium, calcium, magnesium, ammonium, and triethanol amine; saccharides such as monosaccharides including glucose, fructose, galactose, saccharose, xylose, apiose, libose, and isomerized sugar, oligosaccharides such as disaccharides, trisaccharides, polysaccharides such as dextran, and molasses including them; sugar alcohols such as sorbitol; magnesium silicofluoride; phosphoric acid and salts thereof or boric esters; aminocarboxylic acids and salts thereof; alkali-soluble proteins; humic acid; tannic acid; phenols; polyhydric alcohols such as glycerin; and phosphonic acid and derivatives thereof such as amino tri-(methylene phosphonic acid), 1-hydroxyethylidene-1, 1-diphosphonic acid, ethylene diamine tetra(methylenephosphonic acid), and diethylene triamine penta(methylenephosphonic acid), and alkali metal salts and alkaline earth metal salts thereof. (4) high-early-strength admixture accelerating admixture: soluble calcium salts such as calcium chloride, calcium nitrite, calcium nitrate, calcium bromide, and calcium iodide; chlorides such as iron chloride and magnesium chloride; sulfates; potassium hydroxide; sodium hydroxide; carbonates; thiosulfates; formic acid and formates such as calcium formate; alkanol amine; alumina cement; and calcium aluminate silicate. (5) Other surfactants: aliphatic monohydric alcohols such as octadecyl alcohol and stearyl alcohol which has 6-30 carbon atoms in the molecular, alicyclic monohydric alcohols such as abiethyl alcohol which have 6-30 carbon atoms in the molecular, monohydric mercaptans such as dodecyl mercaptan which have 6-30 carbon atoms in the molecular, alkyl phenols such as nonyl phenol which have 6-30 carbon atoms in the molecular, amines such as dodecyl amine which have 6-30 carbon atoms in the molecular unit, and polyoxy alkylene derivatives having 10 or more mols of oxyalkylene such as ethylene oxide and propylene oxide added to carboxylic acids such as lauric acid and stearic acid which have 6-30 carbon atoms in the molecular unit; alkyl diphenyl ether sulfonates having ether linked thereto two phenyl groups containing a sulfonic group and optionally containing an alkyl group or an alkoxyl group as a substituent; various anionic surfactants; various cationic surfactants such as alkyl amine acetate and alkyl trimethyl ammonium chloride; various nonionic surfactants; and various amphoteric surfactants. (6) Waterproof agents: fatty acids (salts), fatty acid esters, oils and fats, silicon, paraffin, asphalt, wax, etc. (7) Corrosion inhibitors: nitrites, phosphates, and zinc oxide. (8) Crack inhibitors: polyoxyalkyl ethers and alkane diols such as 2-methyl-2,4-pentadiol etc. (9) Expansive additives: ettringite and coal. (10) AE agent: Resin soap, saturated or unsaturated fatty acids, sodium hydroxystearate, lauryl sulfate, ABS (alkylbenzene sulfonic acid), LAS (linear alkylbenzene sulfonic acid), alkane sulfonate, polyoxyethylene alkyl(phenyl)ether, polyoxyethylene alkyl(phenyl)ether sulfuric acid ester and salts thereof, polyoxyethylene alkyl(phenyl)ether phosphoric acid ester or salts thereof, proteinous materials, alkenyl sulfosuccinic acid, α-olefin sulfonate, etc.

As concrete examples of the other known cement additive, defoamer, cement wetting agent, thickener, separation reducing agent, coagulating agent, strength enhancer, self-leveling agent, coloring agent, mildew proofing agent, blast furnace slag, fly ash, cinder ash, clinker ash, husk ash, silica fume, silica powder, and gypsum may be cited. These known cement additives may be used either singly or in the form of a combination of two or more members.

The admixture composition for hydraulic material can be widely applied to the known methods of construction using concrete. The method of construction is not particularly restricted. As concrete examples of the method of construction, high-strength concrete construction, super-high strength concrete construction, high-flowing concrete construction, and flowing concrete construction may be cited. The form of use of the composition is not particularly restricted. The composition, for example, may be used directly in a solid form or in the form of powder. Alternatively, it may be blended with water and used in the form of an aqueous solution or a water dispersion, for example.

The hydraulic material to which the admixture composition for hydraulic material is applied is not particularly restricted but is only required to have hydraulicity or potential hydraulicity. As concrete examples of the hydraulic material, Portland cements such as ordinary Portland cement and high-early-strength Portland cement; various blended cements such as silica cement, fly-ash cement, blast furnace cement, high alumina cement, and high belite content cement; cement components such as tricalcium silicate, dicalcium silicate, tricalcium aluminate, and tetracalcium iron aluminate; and fly ash possessing potential hydraulicity may be cited. These hydraulic materials may be used either singly or in the form of a combination of two or more members. Among hydraulic materials, the ordinary Portland cement is generally used particularly advantageously.

The amount of the admixture composition for hydraulic material to be used is preferably in the range of 0.0001-15 weight %, more preferably 0.001-10 weight %, still more preferably 0.005-7 weight %, and most preferably 0.01-5 weight %, as reduced to solids content based on the weight of the hydraulic material. If this amount falls short of 0.0001 weight %, the shortage will possibly result in degrading the effect of the present invention. If the amount exceeds 15 weight %, the excess will tend to retard the setting of the hydraulic material.

The admixture composition for hydraulic material is preferably formulated in the cement composition among conceivable compositions for hydraulic material. The cement composition is not particularly restricted but may be arbitrarily selected from among known cement compositions. As examples of the known cement composition, cement water paste (cement water slurry) containing cement and water; mortar containing cement, water and sand; and concrete containing cement, water, sand, and gravels may be cited.

The cement to be incorporated in the cement composition is not particularly restricted but may be arbitrarily selected from known cements. As concrete examples of the known cement, Portland cements such as ordinary Portland cement and high-early-strength Portland cement; and various blended cement such as silica cement, fly-ash cement, blast furnace cement, alumina cement, and belite high content cement may be cited. These known cements may be used either singly or in the form of a combination of two or more members. The Portland cement is popularly used among other known cements and adapted to allow favorable application of the cement additive mentioned above.

The proportion of the cement additive to the cement composition is not particularly restricted. The weight ratio of the admixture composition for hydraulic material, which is an essential component of the cement additive, to the cement is preferably in the range of 0.0001-15 weight %, more preferably 0.001-10 weight %, still more preferably 0.005-7weight %, and most preferably 0.01-5 weight %, as reduced to solids content, based on the weight of the cement. If this amount falls short of 0.0001 weight %, the shortage will possibly result in preventing the effect of the present invention from being fully manifested. If the amount exceeds 15 weight %, the excess will possibly tend to retard the setting of the cement composition.

The proportion of the water formulated in the cement composition is not particularly restricted. This proportion is preferably in the range of 10-80 weight %, more preferably 15-75 weight %, and still more preferably 20-70 weight %, and most preferably 25-65 weight %, based on the weight of the cement. If this proportion falls short of 10 weight %, the shortage will possibly result in preventing the components from being blended enough to be molded satisfactorily in a prescribed shape and lowering the strength of the molded mass. If the proportion exceeds 80 weight %, the excess will possibly result in lowering the strength of the hardened mass of the cement composition.

When the cement composition is used as mortar or concrete, the sand and gravels formulated in the cement composition is not particularly restricted but maybe arbitrarily selected from those that have been used in the known cement compositions. As examples of the sand and gravels, natural fine aggregates such as river sand, sea sand, and mountain sand which are formed by the natural action from rock; artificial fine aggregates obtained by pulverizing such rock or slag; and light-weight fine aggregates may be cited. The amount of the sand to be formulated is not particularly restricted but is only required to be the same as in the known cement composition. Further, the amount of the gravels to be formulated is also not particularly restricted but is only required to be the same as in the known cement composition. The sand-total aggregate ratio, for example, is preferably in the range of 20-60 weight % and more preferably 30-50 weight %. If this ratio falls short of 20 weight %, the shortage will possibly compel the cement composition to produce a concrete of coarse surface and, in a concrete of a large slump, tend to induce separation of coarse aggregates and mortar component. If the ratio exceeds 60 weight %, the excess will possibly require increasing the unit amount of cement and the unit amount of water and impart inferior fluidity to the concrete.

The cement composition may optionally include other materials. The other materials is not particularly restricted but is only required to be the same as in the known cement composition. As concrete examples of the other materials, silica fume, blast furnace slag, silica powder, and fibrous materials such as steel fibers and glass fibers may be cited. The amount of such other materials to be formulated is not particularly restricted but is only required to be the same as in the known cement composition.

The method for manufacturing the cement composition is not particularly restricted. As concrete examples of this method, the same method as used for the conventional cement composition, namely the method which comprises adding the cement additives or the aqueous solution or the aqueous dispersion thereof while blending cement and water optionally with other materials and then blending them altogether; the method which comprises preparatorily blending cement and water optionally with other material, adding the cement additives or the aqueous dispersion or the aqueous solution thereof to the resultant mixture, and blending them altogether; the method which comprises preparatorily blending cement and other materials required optionally, adding the cement additives or the aqueous dispersion or the aqueous solution thereof and water to the resultant mixture, and blending them altogether; and the method which comprises preparatorily blending cement, the cement additives or the aqueous dispersion or the aqueous solution thereof, and optionally other materials, adding water to the resultant mixture, and blending them altogether may be cited.

The cement composition mentioned above yields a hardened mass which excels in strength and durability and, therefore, contributes for exalting the safety of the building and repressing the cost of repair. The cement composition mentioned above can be widely used advantageously in various fields of civil engineering and building construction. This cement composition also constitutes one of the preferred embodiments of the present invention.

### EXAMPLES

Now, the present invention will be described more specifically below by adducing working examples. It should be noted, however, that the present invention is not limited to these working examples. The “part” and “%” used in the working examples respectively mean “part by weight” and “% by weight” unless otherwise specified.

### Example 1

A concrete composition was prepared by using tetramethoxy silane (TMOS) made by Shin-etsu Chemical Industry Co., Ltd. as an admixing agent.

The components were weighed out in accordance with the following concrete formulation to form a total volume of mixture of 30 L.

| | |
|---|---|
| Unit amount of cement: | 320.0 kg/m³ |
| Unit amount of water | 200.0 kg/m³ |
| Unit amount of fine aggregate | 895.7 kg/m³ |
| Unit amount of coarse aggregate | 905.7 kg/m³ |

Ordinary Portland cement (made by Taiheiyo Cement K.K.; specific gravity 3.16) was used as the cement, Ogasayama sand (specific gravity 2.62 and FM value 2.75) as the fine aggregate, and Oume crushed stone (specific gravity 2.65 and FM value 6.65) as the coarse aggregate.

The kneading of concrete was carried out as follows. The fine aggregate was placed in a biaxial forced kneading mixer (55 L in inner volume), dry mixed therein for 10 seconds, and then brought to a stop by discontinuing the rotation of the mixer. The cement was further placed in the mixer, dry mixed therein for 10 second, and brought to a stop similarly. Then, water containing the amount of an admixture shown in Table 1 was added to the mixer, kneaded with the other components already contained in the mixer for 90 seconds, and then brought to a stop similarly. The coarse aggregate was further added to the mixer and kneaded with the formerly placed components for 90 seconds. Subsequently, the produced concrete composition was withdrawn from the mixer. The concrete composition (fresh concrete) was tested for slump value and amount of entrained air and rated for the shrinkage reducing property. The results are shown in Table 1.

The slump value, the amount of entrained air, and the shrinkage reducing property were rated by the following methods.

Slump value: JIS (Japanese Industrial Standard) A 1101-1998 (method of slump test for concrete)

Amount of entrained air: JIS A 1128-1999 (method for testing fresh concrete for amount of entrained air by means of pressure)

Shrinkage reducing property: JIS A 1129-3: 2001 (method for testing mortar and concrete for change in length, Part 3: dial gauge method)

### Comparative Example 1

A concrete composition was prepared by following the procedure of Example 1 while using an admixture (an alkylene oxide adduct of lower alcohol) instead. The concrete composition (fresh concrete) consequently obtained was tested for slump value and amount of entrained air and rated for the shrinkage reducing property. The results are shown in Table 1.

TABLE 1

| | | | Amount of air | Shrinkage |
|---|---|---|---|---|
| | Admixture | Slump | entrained | strain |
| | (amount) | (cm) | (vol %) | (28^{th} day) |
| Example 1 | TMOS | 19.0 | 0.8 | 314 × 10⁻⁶ |
| | (0.5 mass %) | | | |
| Comparative | None | 19.0 | 0.8 | 471 × 10⁻⁶ |
| Example 1 | (—) | | | |
| Comparative | Alkylene Oxide | 18.0 | 0.7 | 291 × 10⁻⁶ |
| Example 1 | Adduct of Lower | | | |
| | Alcohol | | | |
| | (4.0 mass %) | | | |

As shown in Table 1, the concrete which had incorporated 0. 5% of TMOS was found to have the shrinkage strain largely improved on the 28^{th} day of drying as compared with the plain concrete which had incorporated no admixture.

While alkylene oxide adduct of lower alcohol, a commercially available shrinkage reducing agent, attained a similar shrinkage strain, it required addition in an amount of 2 mass %, i.e. a large amount as compared with TMOS. It is inferred that this agent, if added in an amount of 0.5 mass %, would show a low reduction of shrinkage as compared with TMOS. The data indicates that the adoption of this invention resulted in accomplishing a sufficient reduction in shrinkage at a smaller application rate, repressing the occurrence of a crack in a concrete structure, and imparting durability to the concrete structure.

### Examples 2-6 and Comparative Example 2

Compound A-Compound F to be used as additives for hydraulic material were prepared by the following procedure.

(Compound A) PGM-10 Ester of Tetramethoxy silane Oligomer

A vacuum distiller furnished with a Liebig's cooler bottomed with a 100-ml three-necked flask fitted with a thermometer and a receptacle was charged with 3.81 parts of tetramethoxy silane, 0.36 parts of water, 0.038 parts of p-toluene sulfonic acid monohydride, and 1.28 parts of methanol as a reaction solvent. The resultant reaction solution was heated to 65° C. by the use of an oil bath and stirred for one hour by the use of a magnetic stirrer to obtain a hydrolyzate of tetramethoxy silane (TMOS).

The reaction product consequently obtained and 18.9 parts of methoxy polyethylene glycol (having an average addition mol number of 10 of ethylene oxide) were added together and heated to 105° C. The resultant heated mixture was decompressed to 50 mmHg over a period of two hours to expel methanol by distillation and obtain 19.3 parts of a colorless transparent liquid (Compound A).

(Compound B) PGM-10 Ester of Tetramethoxy Silane

A vacuum distiller furnished with a Liebig's cooler bottomed with a 100-ml three-necked flask fitted with a thermometer and a receptacle was charged with 3.81 parts of tetramethoxy silane, 47.25 parts of methoxy polyethylene glycol (having an average addition mol number of 10 of ethylene oxide), and 0.136 parts of a methanol 28% sodium methoxide solution. The resultant reaction solution was heated to 105° C. by the use of an oil bath. It was decompressed to 70 mmHg over a period of two hours and heated to 125° C. The reaction solution and N₂ gas kept blown into the solution at 0.8 ml/min were stirred together under 90 mmHg for two hours to obtain 48.1 parts of a colorless transparent liquid (Compound B).

(Compound C) Polymerization of Methacrylic Acid to PGM-10 Ester of Methoxy Silane Oligomer

A vacuum distiller furnished with a Liebig's cooler bottomed with a 100-ml three-necked flask fitted with a thermometer and a receptacle was charged with 4.57 parts of tetramethoxy silane, 0.36 parts of water, 3.93 parts of 3-mercaptopropyl trimethoxysilane, 0.0446parts of p-toluene sulfonic acid monohydride, and 1.28 parts of methanol as a reaction solvent. The resultant reaction solution was heated to 65° C. by the use of an oil bath and stirred for one hour by the use of a magnetic stirrer to obtain a hydrolyzate of methoxy silane.

The reaction product consequently obtained and 37.8 parts of methoxy polyethylene glycol (having an average addition mol number of 10 of ethylene oxide) were added together and heated to 110° C. The resultant heated mixture was decompressed to 50 mmHg over a period of two hours to expel methanol by distillation.

The reaction product consequently obtained, 0.043 parts each of 2,2′-azobisisobutylonitrile (made by Wako Pure Chemical Industries, Ltd. and sold under the trademark designation of “V-65”) and 2,2′-azobis(2,4-dimethyl valeronitrile) (made by Wako Pure Chemical Industries, Ltd. and sold under the trademark designation of “V-65”) as initiators, and 8.61 parts of methacrylic acid. The reaction solution kept at a bath temperature of 70° C. and a small amount of N₂ gas kept blown therein were left reacting for one hour. After the reaction, the reaction mixture was heated to 90° C. and decompressed to 50 mmHg and kept stirred in the resultant state for 30 minutes to cut a light boiling component and obtain 47.0 parts of a lightly yellow transparent liquid (Compound C).

(Compound D) Polymerization of Acrylic Acid to PGM-10 Ester of Methoxy Silane Oligomer

A vacuum distiller furnished with a Liebig's cooler bottomed with a 100-ml three-necked flask fitted with a thermometer and a receptacle was charged with 2.82 parts of tetramethoxy silane, 0.36 parts of water, 1.96 parts of 3-mercapto propyl trimethoxy silane, 0.023 parts of p-toluene sulfonic acid monohydride, and 1.28 parts of methanol as a reaction solvent. The resultant reaction solution was heated to 65° C. by the use of an oil bath and stirred for one hour by the use of a magnetic stirrer to obtain a hydrolyzate of tetramethoxy silane,

The reaction product consequently obtained and 18.9 parts of methoxy polyethylene glycol (having an average addition mol number of 10 of ethylene oxide) were added together and heated to 110° C. The resultant heated mixture was decompressed to 50 mmHg over a period of two hours to expel methanol by distillation.

The reaction product was cooled. The cooled reaction product, 0.018 parts each of V-60 and V-65, and 3.60 parts of acrylic acid were added together. The reaction solution kept at a bath temperature of 60° C. and a small amount of N₂ gas kept blown therein were left reacting for one hour. After the reaction, the reaction mixture was heated to 90° C. and decompressed to 50 mmHg and stirred in the resultant state to cut a light boiling component and obtain 25.0 parts of a colorless transparent liquid (Compound D).

(Compound E) Polymerization of Methacrylic Acid and PGM-9E to Alkoxy Silane Oligomer

A vacuum distiller furnished with a Liebig's cooler bottomed with a 100-ml three-necked flask fitted with a thermometer and a receptacle was charged with 6.25 parts of tetraethoxy silane, 0.72 parts of water, 3.93 parts of 3-mercaptopropyl trimethoxy silane, 0.031 parts of p-toluene sulfonic acid monohydride, and 3.13 parts of ethanol as a reaction solvent. The resultant reaction solution was heated to 70° C. by the use of an oil bath and stirred for one hour by the use of a magnetic stirrer. The oil bath was heated to 100° C. to induce expulsion of methanol and ethanol by distillation. The resultant reaction solution was further decompressed to 400 mmHg over a period of 30 minutes to expel a light boiling component by distillation and obtain a hydrolyzate of ethoxy silane.

The reaction product consequently obtained, 0.038 parts each of V-60 and V-65 as initiators, 8.61 parts of methacrylic acid, and 29.79 parts of methoxy polyethylene glycol methacrylate (having an average addition mol number of 9 of ethylene oxide) were added together. The reaction solution kept at a bath temperature of 60° C. and a small amount of N₂ gas kept blown therein were left reacting for one hour. After the reaction, the reaction solution was heated to 90° C. and decompressed to 50 mmHg and stirred in the resultant state for 30 minutes to cut a light boiling component and obtain 39.3 parts of a colorless transparent liquid (Compound E).

(Compound F) Polymerization of Methacrylic Acid and PGM-9E to PGM-10 Ester of Methoxy Silane Oligomer

A vacuum distiller furnished with a Liebig's cooler bottomed with a 100-ml three-necked flask fitted with a thermometer and a receptacle was charged with 4.57 parts of tetramethoxy silane, 0.72 parts of water, 3.93 parts of 3-mercaptopropyl trimethoxysilane, 0.046parts of p-toluene sulfonic acid monohydrate, and 1.28 parts of methanol as a reaction solvent. The resultant reaction solution was heated to 65° C. by the use of an oil bath and stirred for one hour by the use of a magnetic stirrer to obtain a hydrolyzate of methoxy silane.

The reaction product consequently obtained and 37.8 parts of methoxy polyethylene glycol (having an average addition mol number of 10 of ethylene oxide) were added together and heated to 110° C. The resultant heated mixture was decompressed to 50 mmHg over a period of two hours to expel methanol by distillation.

The reaction product was cooled. The cooled reaction product, 0.038 parts each of V-60 and V-65 as initiators, 8.61 parts of methacrylic acid, and 29.79 parts of methoxy polyethylene glycol methacrylate (having an average addition mol number of 9 of ethylene oxide) were added together. The reaction solution kept at a bath temperature of 60° C. and a small amount of N₂ gas kept blown therein were left reacting for one hour. After the reaction, the reaction solution was heated to 90° C. and decompressed to 50 mmHg and stirred in the resultant state for 30 minutes to cut a light boiling component and obtain 78.6 parts of a colorless transparent liquid (Compound F).

For the purpose of comparison, a lignin sulfonic acid compound polyol complex, an AE water reducing agent, was prepared. This compound was labeled as “Compound G”.

Compound A-Compound G were each diluted with water to 213.7 g. Each of the diluted compounds, 485.8 g of an ordinary Portland cement made by Taiheiyo Cement Co., Ltd., and 1350 g of standard sand for testing cement for strength (JIS R5201-1997) were kneaded together by the use of a Hobart type mortar mixer (made by Hobart Corp. and sold under the product code of “N-50”). The kneading was carried out in accordance with the method specified in JIS R5201-1997. The amounts of additive used in this case were as shown in Table 2.

The hardened mortar samples obtained were measured on the shrinkage reducing property. Further, the mortar samples before hardening were used for evaluation of the dispersibility of compound A-G.

The mortar specimens for the evaluation of the shrinkage reducing property were manufactured in accordance with JIS R1129. The mortar specimens thus prepared measured 4 H 4 H 16 cm. The molds were coated with silicone grease in advance for preventing water leakage and facilitating mold relief. Gage plugs were attached to the opposite terminals of each mortar specimen. The mold into which the mortar resulting from the kneading was cast was placed in a container, stored therein in a tightly closed state at 20° C., and subjected to initial aging. After two days of aging, the hardened mortar specimen was removed from the mold, brushed with a scrub and water to remove the silicon grease still adhering to the specimen, and subsequently aged in still water at 20° C. for five days.

The change in length of the mortar specimen was measured in accordance with JIS A1129 using an instrument (made by Nishinippon Shikenki Corp. and sold under the trademark designation of “Dial Gauge”). The specimen which had been aged in still water for five days was wiped with a dry towel to remove the water still adhering to the surface thereof and immediately measured for length. The length found at this time was taken as the standard. The specimen was subsequently stored in an air-conditioned chamber kept at a temperature of 20° C. and a humidity of 60% and measured for length with a proper interval. On the 7^{th} day and the 14^{th} day subsequent to the completion of the aging in the still water, the specimen was measured for shrinkage strain. The results are shown in Table 2.

The dispersibility was rated by the use of the flow value.

The flow value was determined in accordance with JIS R5201.

The flow value increases in accordance as the dispersibility gains in excellence.

TABLE 2

| | | Amount | Shrinkage | Shrinkage | Flow |
|---|---|---|---|---|---|
| | | (wt %/ | strain | strain | value |
| | Additive | cement) | (7^{th} day) | (14^{th} day) | (mm) |
| Example 2 | Compound A | 1.0 | 186 | 314 | 152.0 |
| Example 3 | Compound B | 1.0 | 179 | 293 | 144.0 |
| Example 4 | Compound C | 1.0 | 254 | 361 | 180.5 |
| Example 5 | Compound D | 1.0 | 236 | 371 | 166.5 |
| Example 6 | Compound E | 0.1 | 319 | 475 | 196.5 |
| Example 7 | Compound F | 0.1 | 321 | 464 | 168.5 |
| Comparative | Compound G | 0.25 | 336 | 504 | 155.0 |
| Example 2 | | | | | |

As shown in Table 2, the mortars which had incorporated the additive of this invention for hydraulic material excelled in the shrinkage reducing property. The specific compounds accomplished an improvement in dispersibility.

The entire disclosure of Japanese Patent Application No. 2003-162506 filed on Jun. 6, 2003 including specification, claims, drawings and summary are incorporated herein by reference in its entirety.

1. A concrete composition comprising at least tetraalkoxy silane type additive for hydraulic material or tetraalkoxy silane hydrolyzate type additive for hydraulic material.

2. A concrete composition according to claim 1, wherein said tetraalkoxy silane type additive for hydraulic material is selected from the group consisting of tetraalkoxy silane, polyalkylene oxide derivative of tetraalkoxy silane, and acid derivative of tetraalkoxy silane.

3. A concrete composition according to claim 2, wherein said polyalkylene oxide derivative of tetraalkoxy silane and said acid derivative of tetraalkoxy silane are a compound represented by the following formula (1):
(R¹O)ₘSi(OR²)₄₋ₘ (1)
wherein R¹ denotes hydrocarbon group having 1-30 carbon atoms, m denotes an integer of 0-3, R² identically or differently denotes -(AO)ₙR³, —(CR⁴R⁵)ₚCOOM, or —(CR⁶R⁷)_{g}SO₃Q, A denotes linear or branched hydrocarbon group having 2-18 carbon atoms, R³ denotes hydrogen atom or hydrocarbon group having 1-30 carbon atoms, R⁴- R⁷ identically or differently denote hydrogen atom, methyl group, or ethyl group, M and Q identically or differently denote hydrogen, monovalent metal, divalent metal, ammonium, organic amine group, or —(BO)_{d}R⁸, B denotes linear or branched hydrocarbon group having 2-18 carbon atoms, R⁸ denotes hydrogen atom or hydrocarbon group having 1-30 carbon atoms, n denotes an integer of 1-300, p and g identically or differently denote an integer of 1-10, and d denotes an integer of 1-300.

4. A concrete composition according to claim 2, wherein said polyalkylene oxide derivative of tetraalkoxy silane and said acid derivative of tetraalkoxy silane are a compound represented by the following formula (2):
(R⁹O)ᵣSi(OR¹⁰)₄₋ᵣ (2)
wherein R⁹ denotes hydrocarbon group having 1-30 carbon atoms, r denotes an integer of 0-3, R¹⁰ denotes —(CR¹¹V¹—CR¹²V²—O)ₜR¹³, R¹¹ and R¹² identically or differently denote hydrogen atom, hydrocarbon group having 1-18 carbon atoms, or side chain possessing a carboxyl group, V¹ and V² identically or differently denote hydrogen atom or side chain possessing a carboxyl group, the side chain possessing the carboxylic group possesses a repeating unit originating in an unsaturated carboxylic acid type monomer, R¹³ denotes hydrocarbon group possessing 1-30 carbon atoms, t denotes an integer of 1-300, and R¹⁰ contains at least one carboxyl group.

5. A concrete composition according to claim 1, wherein said tetraalkoxy silane hydrolyzate type additive for hydraulic material is selected from the group consisting of hydrolyzate of tetraalkoxy silane, compound obtained by hydrolyzing tetraalkoxy silane and then subjecting the resultant hydrolyzate to derivation with a polyalkylene oxide, and compound obtained by hydrolyzing tetraalkoxy silane and then subjecting the resultant hydrolyzate to derivation with an alkylpolyalkylene oxide.

6. A concrete composition according to claim 1, wherein said tetraalkoxy silane hydrolyzate type additive for hydraulic material is obtained by adding an ethylenically unsaturated monomer containing at least an ethylenically unsaturated carboxylic acid type monomer to a tetraalkoxy oligomer and/or a polyalkylene oxide derivative thereof.

7. A concrete composition according to claim 1, further comprising a water reducing agent.

8. A concrete composition according to claim 7, wherein said water reducing agent is a polycarboxylic acid type high-performance AE water reducing agent.

9. An additive for hydraulic material, comprising a transformed alkoxy silane acid.

10. An additive for hydraulic material according to claim 9, wherein said transformed alkoxy silane acid is a compound represented by the formula (3) or the formula (4): 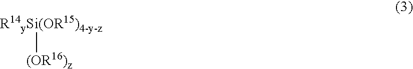
wherein R¹⁴ denotes hydrocarbon group having 1-30 carbon atoms, y and z identically or differently denote an integer of 1-3 and satisfy 2≦y+z≦4, R¹⁵ denotes —(WO)_{b}R¹⁷, R¹⁶ identically or differently denotes —(CR¹⁸R¹⁹)ᵤCOOX or —(CR²⁰R²¹)ₕO₃Y, W denotes linear or branched hydrocarbon group having 2-18 carbon atoms, R¹⁷ denotes hydrogen atom or hydrocarbon group having 1-30 carbon atoms, R¹⁸- R²¹ identically or differently denote hydrogen atom, methyl group, or ethyl group, X and Y identically or differently denote hydrogen, monovalent metal, divalent metal, ammonium, organic amine group, or -(DO)_{f}R²², R²² denotes hydrogen atom or hydrocarbon group having 1-30 carbon atoms, b denotes an integer of 1-300, u and h identically or differently denote an integer of 1-10, and f denotes an integer of 1-300,
R²³_{c}Si(OR²⁴)_{4-c} (4)
wherein R²³ denotes hydrocarbon group having 1-30 carbon atoms, c denotes an integer of 1-3, R²⁴ denotes —(CR²⁵V³—CR²⁶V⁴—O)_{q}R²⁷, R²⁵ and R²⁶ identically or differently denote hydrogen atom, hydrocarbon group having 1-18 carbon atoms, or side chain possessing a carboxyl group, V³ and V⁴ identically or differently denote hydrogen atom or side chain possessing a carboxyl group, the side chain possessing the carboxyl group possesses a repeating unit originating in an unsaturated carboxyl type monomer, R²⁷ denotes hydrocarbon group having 1-30 carbon atoms, q denotes an integer of 1-300, and R²⁴ contains at least one carboxyl group.

11. A concrete composition comprising an additive for hydraulic material of claim 9.

12. A concrete composition according to claim 11, further comprising a water reducing agent.

13. A concrete composition comprising an additive for hydraulic material of claim 10.

14. A concrete composition according to claim 13, further comprising a water reducing agent.
